(19) United States
(12) Patent Application Publication
(10) Pub. No.: US 2019/0068726 A1
(43) Pub. Date: Feb. 28, 2019

(54) SYSTEM AND METHOD FOR OBJECTIVE VERIFICATION OF PHYSICAL ADDRESS OF A USER / RESPONDENT

(71) Applicant: iAccept Softwares Private Limited, Bangalore (IN)

(72) Inventors: Mohan Kumar Balasubramanian, Bangalore (IN); Rohit Mohan, Bangalore (IN)

(21) Appl. No.: 16/109,737

(22) Filed: Aug. 22, 2018

(30) Foreign Application Priority Data
Aug. 24, 2017 (IN) 201741030010

(51) Int. Cl. H04L 29/08; G06F 17/30; H04L 29/12

(52) U.S. Cl. CPC H04L 67/18; G06F 17/3087; H04W 4/029; H04L 67/02; H04L 61/609; H04L 61/15

(57) ABSTRACT

A system and method for objective verification of physical address of a user/respondent is disclosed. The system 101 comprise a processor 201 and a memory 203, coupled with the processor 201. The processor 201 may execute instructions for receiving a data of location co-ordinates at every pre-determined time interval from a user device. The processor 201 may execute instructions for processing the data of location co-ordinates stored in a log file. The processor 201 may execute instruction for generating a location data patterns with respect to time and co-ordinates by performing statistical analysis on the log file. The processor 201 may perform matching of the location data pattern with a pre-stored physical address of the user associated with the user device 103. Further, the processor 201 may execute instructions for generating a verification report based on the matched data.

### CROSS-REFERENCE To RELA IED APPLICATIONS AND PRIORITY

The present application claims priority from Indian patent application no. 201741030010 filed on 24 Aug. 2017.

### TECHNICAL FIELD

The present subject matter described herein, in general, relates to a system and method for objective verification of physical address of a user/respondent.

### BACKGROUND

The current system of address verification involves a person physically visiting the designated premises to verify the addresses, including street names etc while validating the fact that the resident is actually staying there. This is done by asking the resident to produce documents like telephone/electricity bill or rent receipts, rental or lease agreements or any other government issued document connecting the address with the identity of the resident. However, this process is susceptible to errors, if many individuals are sharing the same premises or if residents are from economically or socially backward strata. The reason being that they may not have documentations like rental agreements, receipts etc. The verifying person, who is responsible to attest the fact that the resident is actually residing in the said place, may wilfully manipulate or purposefully record an untrue scenario, for an illegal consideration. The verifying person may also be misled by neighbours when he goes to verify this piece of information. The current verification process is highly dependent on a single observation/witness attesting the said fact.

Further, the available systems in the market fail to provide accurate verification due to change in the location of the user. There are chances of manipulation of data by the fraud user.

Thus, there is long standing need of tamper proof and reliable system which provide objective verification of physical address of a user/respondent. Further, there is need of accurate objective verification of physical address of a user/respondent system and method which may consider changing factors and accordingly adjust the processing parameters.

### SUMMARY

This summary is provided to introduce concepts related to a system and method for objective verification of physical address of a user/respondent concepts are further described below in the detailed description. This summary is not intended to identify essential features of the claimed subject matter nor is it intended for use in determining or limiting the scope of the claimed subject matter.

In an implementation, a system for objective verification of physical address of a user/respondent. In one aspect, the system comprises a processor and a memory coupled with the processor. The processor is configured to execute programmed instructions stored in the memory. The processor is configured to execute instruction for receiving a data of location co-ordinates at every pre-determined time interval from a user device wherein the processor is communicatively coupled with the user device. The processor is configured to execute instructions for processing the data of location co-ordinates stored in a log file. The log file is generated after receiving the data of location co-ordinates. The processor is configured to execute instruction for generating a location data patterns with respect to time and co-ordinates by performing statistical analysis on the log file. The processor is configured to execute instruction for matching, the location data pattern with a pre-stored physical address of the user associated with the user device. The processor is configured to execute instruction for generating, a verification report based on the matched data.

In another implementation, a method for objective verification of physical address of a user/respondent. In one aspect, the method comprises receiving, via a processor, a data of location co-ordinates at every pre-determined time interval from a user device wherein the processor is communicatively coupled with the user device. Further, the method comprises processing, via the processor, the data of location co-ordinates stored in a log file. The log file is generated after receiving the data of location co-ordinates. The method comprises generating, via the processor, a location data patterns with respect to time and co-ordinates by performing statistical analysis on the log file. The method comprises matching, via the processor, the location data pattern with a pre-stored physical address of the user associated with the user device. The method comprises generating, via the processor, a verification report based on the matched data.

### BRIEF DESCRIPTION OF DRAWINGS

The detailed description is described with reference to the accompanying Figures. In the Figures, the left-most digit(s) of a reference number identifies the Figure in which the reference number first appears. The same numbers are used throughout the drawings to refer like features and components.

FIG. 1, illustrates an implementation 100 of a system 101 for objective verification of physical address of a user/respondent, in accordance with an embodiment of the present subject matter.

FIG. 2, illustrates components of the system 101, in accordance with an embodiment of a present subject matter.

FIG. 3, illustrates the method 300 for objective verification of physical address of a user/respondent, in accordance with an embodiment of the present subject matter.

FIG. 4, illustrates a heat map indicating the frequency of visits & duration of stay, in accordance with an embodiment of the present subject matter.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

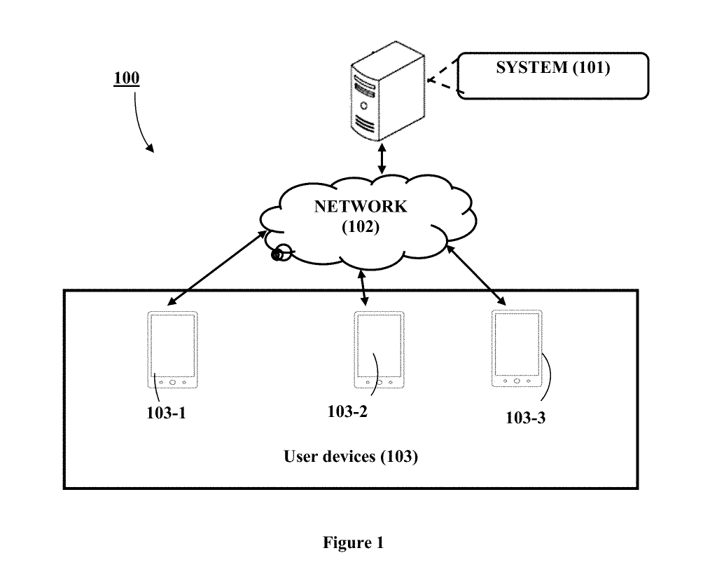

Referring to FIG. 1, an implementation 100 of a system 101, for objective verification of physical address of a user/respondent, is illustrated in accordance with an embodiment of the present subject matter. In one implementation, the system 101 may be connected to a user device 103 through a network 102. It will be understood that the system 101 may be accessed by multiple users through one or more user devices 103-1, 103-2,103-3, collectively referred as user device 103 hereinafter, or user 103, or applications residing on the user device 103.

In an embodiment, as illustrated in FIG. 1, the system 101 may accept information provided by multiple users 103-1,103-2,103-3 using the user device 103, to register the respective user with the system 101.

In an embodiment, though the present subject matter is explained considering that the system 101 is implemented as a server, it may be understood that the system 101 may also be implemented in a variety of user devices, such as a but are not limited to, a portable computer, a personal digital assistant, a handheld device, a mobile, a laptop computer, a desktop computer, a notebook, a workstation, a mainframe computer, and the like.

In one implementation, the network 102 may be a wireless network, a wired network or a combination thereof. The network 102 can be accessed by the device using wired or wireless network connectivity means including updated communications technology.

In one implementation, the network 102 may be a wireless network, a wired network or a combination thereof. The network 102 can be implemented as one of the different types of networks, cellular communication network, local area network (LAN), wide area network (WAN), the internet, and the like. The network 102 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 102 may include a variety of network devices, including routers, bridges, servers, computing devices, storage devices, and the like

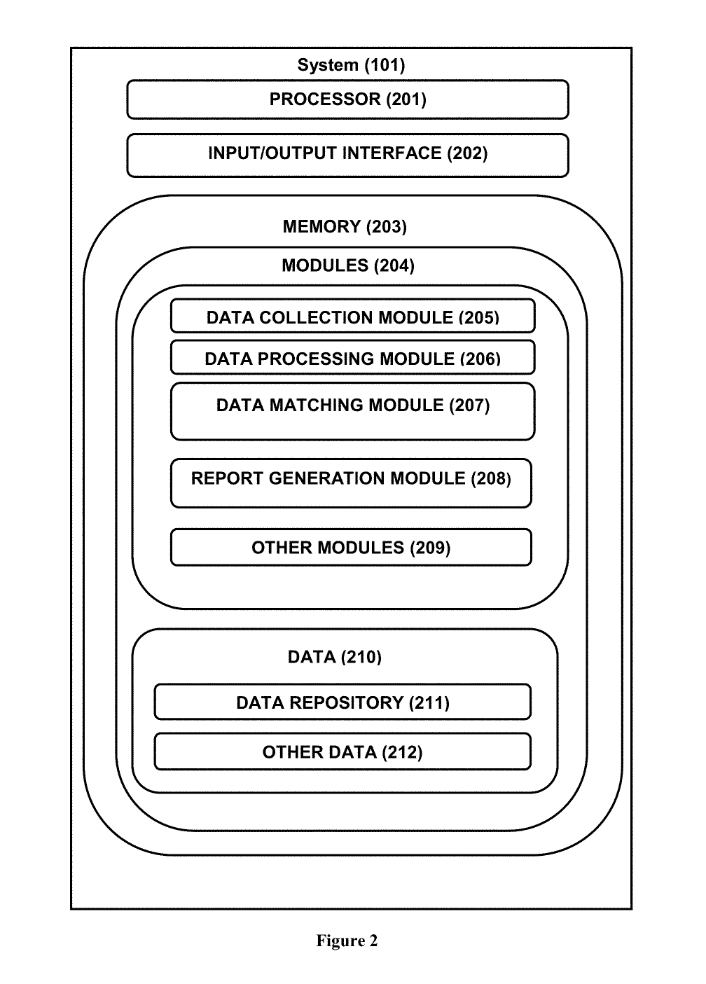

Referring to FIG. 2, components of the system 101, comprises at least one processor 201, an input/output (I/O) interface 202, a memory 203, modules 204 and data. In one embodiment, the at least one processor 201 is configured to fetch and execute computer-readable instructions stored in the memory 203.

In one embodiment, the I/O interface 202 implemented as a mobile application or a web based application may include a variety of software and hardware interfaces, for example, a web interface, a graphical user interface, and the like. The I/O interface 202 may allow the system 101 to interact with the user devices 103. Further, the I/O interface 202 may enable the user device 103 to communicate with other computing devices, such as web servers and external data servers (not shown). The I/O interface 202 can facilitate multiple communications within a wide variety of networks and protocol types, including wired networks, for example, LAN, cable, etc., and wireless networks, such as WLAN, cellular, or satellite. The I/O interface 202 may include one or more ports for connecting to another server.

In an exemplary embodiment, the I/O interface 202 is an interaction platform which may provide a connection between users and system 101. In one embodiment, the I/O interface 202 feeds data into a data collection module 205 which resides in the memory 203.

In an implementation, the memory 203 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and memory cards. The memory 203 may include modules 204 and data 210.

In one embodiment, the modules 204 include routines, programs, objects, components, data structures, etc., which perform particular tasks, functions or implement particular abstract data types. In one implementation, the modules 204 may include a data collection module 205, a data processing module 206, a data matching module 207, a report generation module 208 and other module 209.

In one embodiment, the data collection module 205, may receive data from I/O interface 202. In one embodiment, the data collection module 205 may receive the data of location co-ordinates at every pre-determined time interval from the user device 103. In one exemplary embodiment, the data collection module 205 may receive data of location co-ordinates at every hour or at short time interval. In one embodiment, the system 101 may enable the user device 103 to ping location co-ordinates at pre-determined time interval. In one embodiment, the system 101 may enable the user device 103 to set a pinging frequency at pre-determine time interval. In one embodiment, the processor 201 may be communicatively coupled with the user device 103. In one embodiment, the processor 201 may be communicatively coupled with the user device 103 using at least one communication protocol selected from the group of GPS, GPRS, 2G, 3G, GSM and wi-fi technology. In one exemplary embodiment, the data of location co-ordinates may comprise GPS co-ordinates such as latitude and longitude address of the location. In one exemplary embodiment, the data of location co-ordinates may be captured by GPS of the user device 103.

In one embodiment, the data processing module 206 may process the data of location co-ordinates stored in a log file. In one embodiment, the data of location co-ordinates received by the data collection module 205 may be stored in the log file. In one embodiment, the log file may be stored in the data repository 211. The data processing module 206 may be configured to generate a location data patterns with respect to time and co-ordinates from the data of location co-ordinates stored in log file. The data processing module 206 may plot the location data patterns with respect to time and identify clusters in data. In one exemplary embodiment, clustering algorithm and parameter settings (like using the distance function, a density threshold or the number of expected clusters) may be automatically selected by integrating artificial intelligence in the data analysis. The data processing module 206 may generate the location data patterns by performing statistical analysis on the log file. In an exemplary embodiment, a probabilistic graphical modelling may be used to perform statistical analysis of the data of location co-ordinates stored in log file.

In one embodiment, the data matching module 207 may be configured to perform matching of the location data pattern with a pre-stored physical address of the user associated with the user device 103. In one exemplary embodiment, the user device 103 may enable user to provide physical address of the user such as residential place address. In one embodiment, the physical address may be stored in the memory 203.

In one embodiment, the report generation module 208 may be configured to generate verification report based on the matched data. In one embodiment, the verification report may be displayed on the user device 103.

In one embodiment, the data 210 may comprise data repository 211 and other data 212. The data repository 211 may be configured to store the data processed, received, and generated by one or more of the modules 204. The other data 212 may include data generated as a result of the execution of one or more modules.

In one exemplary embodiment, the user may approach the system 101 for verification of the address using user device 103. The user may register with the system 101 using application stored on the computer based platform and registers the user information details such as residential address, work address of the user. The user device 103 associated with the user may be configured to transmit location address co-ordinates every hour or at every short-term interval using GPS/GPRS. The system 101 may receive the data of location co-ordinates. The system 101 may store the data of location co-ordinates in the log file. The system 101 may process the data of location co-ordinates stored in the log file. Further, the system 101 may perform statistical analysis to generate the location data patterns with respect to time and co-ordinates. The location data pattern is generated by using the probabilistic graphical modelling. In one embodiment, the probabilistic graphical modelling may be used with anomaly detection to validate address. In one embodiment, the system is configured to determine change in the location and accordingly increases the pinging frequency of the user device 103 closer to pre-determined time interval in order to receive the data of location co-ordinates. In one embodiment, the system 101 may use algorithms like Viterbi and unifilar Markov source property is used to confirm location. The system 101 may match, the location data pattern with a pre-stored physical address of the user associated with the user device. The system 101 may generate verification report based on the matched data. If the user has registered residential address A and work address B. The system 101 may perform statistical analysis to generate location data pattern using the location co-ordinates received from the user device 103 from pre-determined time interval. The system 101 may match location data pattern with residential address A and work address B and generate verification report. In one exemplary embodiment, the verification report may display total visits of the user to the residential address A and work address B in percentages.

In one exemplary embodiment, the user may approach the system 101 for objective verification of physical address of the user/respondent. The user associated with the user device 103 may register to the system 101 using application stored on the computer based platform. In one embodiment, the user may register the physical address of the user/respondent which need to be verified. In one exemplary embodiment, the physical address may be work address or residential address. In one embodiment, the user may locate or pin address of the user/respondent on the map using I/O interface of the user device 103. In one embodiment, the system 101 may store the physical address of the user/respondent. The system 101 may receive the data of location co-ordinates at every pre-determined time interval from a user device. In one embodiment, the system 101 may receive the data of one or more location co-ordinates at every pre-determined time interval from a user device. In one embodiment, data of location coordinate is captured by its latitude and longitude. Now referring to Table 1, each location data set is represented by A, B, C etc., in accordance with the present subject matter. For each location co-ordinate, a variation of ±20 M is permitted while storing the location. In one exemplary embodiment, if location A (x, y) represented by all sets of coordinates as A, then variation of all coordinates (x±20 m, y±20 m) is permitted while storing the location. In one embodiment, the system 101 may represent a circular area of diameter 40 m of location co-ordinates, which is used to pin point the physical address of the user/respondent.

In one embodiment after receiving the data of location co-ordinates, the system 101 may generate the log file and store the data of location co-ordinates with respect to time interval. The system 101 may perform processing of the data of location co-ordinates. Further, the system 101 may generate the location data patterns with respect to time and co-ordinates by performing statistical analysis on the log file. In the log file, the first iteration may begin at interval of every hour (Day 1). When the system 101 notices that there is a change in address, from A to B at the 3. AM in the log file and again a change in address at the 10 AM in the log file. So, accordingly, system 101 may reduce of intervals to 20 minutes. In one exemplary embodiment, the system 101 may increase frequency of pings from the user device 103. When the sampling cycle for the next day (Day 2) begins, the user device pings at 2.40 AM and finds that the location is A & pings again at 3.00 AM & 3.20 AM. At 3.20 AM the location is B and at 3.40 AM it is C. This frequency of the pinging process continues as on Day 1, till 9.40 AM, when the location is C. In one embodiment, the system is configured to increases the pinging frequency closer to the original set time to collect data of the location when there is a change in location. In one embodiment, the pinging frequency reverts back to the original anchored pre-sets, when there is no change in locations in consecutive readings.

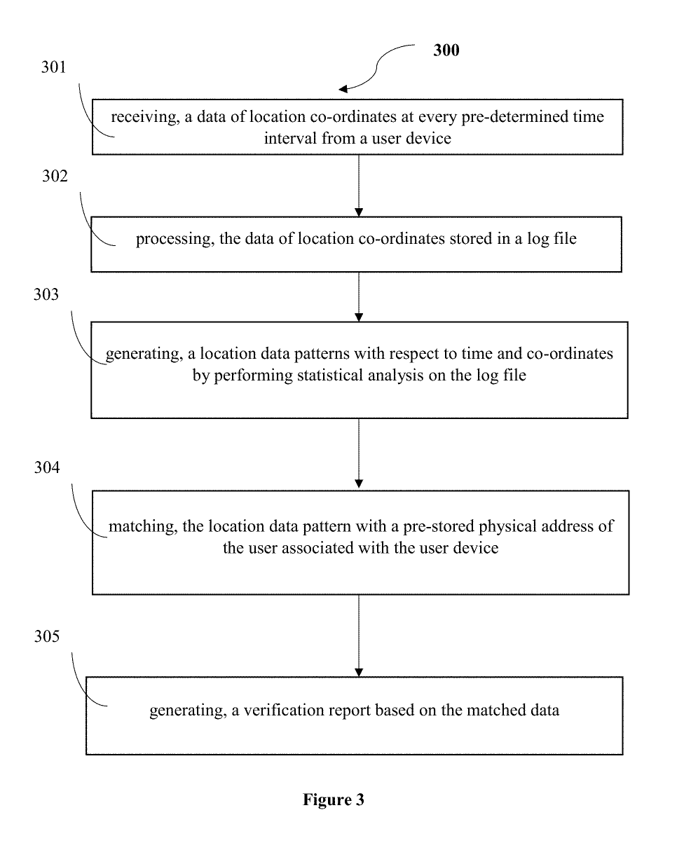

FIG. 3 illustrates a method 300 depicting stepwise process for objective verification of physical address of the user/respondent, in accordance with the present subject matter. The user may initiate the method 300 by clicking on the application icon using the I/O interface 202. The user may register to the application stored on the computer based platform accepts and registers the user information details such as physical address of the user.

At step 301, the processor 201 may execute instruction stored in the data collection module 205 to receive the data of location co-ordinates at every pre-determined time interval from the user device 103. In one embodiment, the processor 201 is communicatively coupled with the user device 103.

At step 302, the processor 201 may execute instructions stored in the data processing module 206 to process the data of location co-ordinates stored in the log file.

At step 303, the processor 201 may execute instructions stored in the data processing module 206 to generate the location data patterns with respect to time and co-ordinates from the data of location co-ordinates stored in the log file. In one embodiment, the probabilistic graphical modelling may be used with anomaly detection to validate the physical address. In one embodiment, the method may determine change in the location and accordingly increase the pinging frequency of the user device 103 closer to the pre-determined time interval in order to receive the data of location co-ordinates. In one embodiment, the method 300 may utilize algorithms like Viterbi and Unifilar Markov source property to confirm the location.

At step 304, the processor 201 may execute instructions stored in the data matching module 207 in order to match the location data pattern with a pre-stored physical address of the user associated with the user device 103.

At step 305, the processor 201 may execute instructions stored in the report generation module 208 in order to generate verification report based on the matched data.

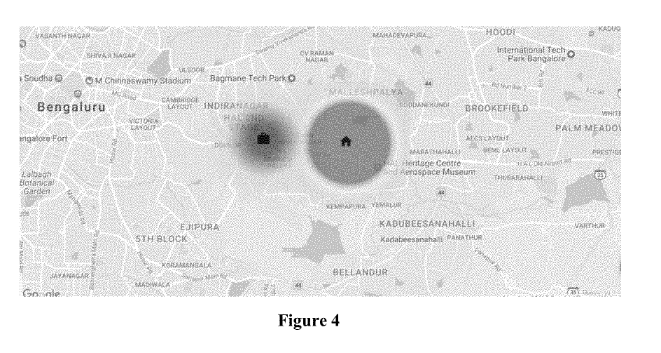

Now referring to FIG. 4, a heat map indicating the frequency of visits & duration of stay is illustrated, in accordance with the present subject matter. In one exemplary embodiment, the system 101 may be configured to display the heat map indicating the frequency of visits & duration of stay of the user/respondent at work place and residential address. In one embodiment, the heat map is a graphical representation of data where the frequency of visits & duration of stay are represented by colour.

Exemplary embodiments discussed above may provide certain advantages. Though not required to practice aspects of the disclosure, these advantages may include those provided by the following features.

Some embodiments of the present disclosure may enable the system and method used to prevent fraudulent usage of the application and to detect any rigging of data.

Some embodiments of the present disclosure may enable the system and method to be used for to prevent fraudulent usage of the application and also to detect any rigging of data.

Some embodiments of the present disclosure may enable the system and method to be provide in built checks in the application to avoid manipulation of data by the user.

Some embodiments of the present system and method may use statistically reliable datasets wherein frequency & duration of stay may be captured using GPS/GPRS and such geo tagging tools.

Some embodiment of the present system and method may use deep learning methods of Artificial Intelligence models, thus able to prove by using data of date, time & duration of stay in order to establish the claimed address or place of residence.

Some embodiments of the present system and method may use discrete pinging to conserve battery/power of the user device.

Some embodiments of the present system and method may use algorithm(s) which determine the frequency and the intervals between the readings in order to fine-tune the location.

We claim:

1. A system for objective verification of physical address of a user/respondent, the system comprising
a processor 201, and
a memory 203 coupled with the processor 201, wherein the processor is configured to execute programmed instructions stored in the memory for
receiving, a data of location co-ordinates at every pre-determined time interval from a user device wherein the processor 201 is communicatively coupled with the user device 103;
processing, the data of location co-ordinates stored in a log file, wherein the log file is generated after receiving the data of location co-ordinates;
generating, a location data patterns with respect to time and co-ordinates by performing statistical analysis on the log file;
matching, the location data pattern with a pre-stored physical address of the user associated with the user device;
generating, a verification report based on the matched data.

2. The system of claim 1, wherein the processor 201 is communicatively coupled with the user device using at least one communication protocol selected from the group of GPS, GPRS, 2G, 3G, GSM and wi-fi technology.

3. The system of claim 1, wherein the user device 103 is configured to collect the data of location co-ordinates using GPS.

4. The system of claim 1, wherein a probabilistic graphical modelling is used to perform statistical analysis of the log file.

5. The system of claim 1, wherein the user device 103 is configured to enable the user to provide physical address of the user/respondent.

6. The system of claim 1, further configured to determine change in the location and accordingly increases the pinging frequency closer to pre-determined time interval in order to receive the data of location co-ordinates.

7. A method 300 for objective verification of physical address of a user/respondent, the method comprising
receiving, via a processor 201, a data of location co-ordinates at every pre-determined time interval from a user device wherein the processor is communicatively coupled with the user device;
processing, via the processor 201, the data of location co-ordinates stored in a log file, wherein the log file is generated after receiving the data of location co-ordinates;
generating, via the processor 201, a location data patterns with respect to time and co-ordinates by performing statistical analysis on the log file;
matching, via the processor 201, the location data pattern with a pre-stored physical address of the user associated with the user device;
generating, via the processor 201, a verification report based on the matched data.

8. The method of claim 7, wherein the processor 201 is communicatively coupled with the user device using at least one communication protocol selected from the group of GPS, GPRS, 2G, 3G, GSM and wi-fi technology.

9. The method of claim 7, further collecting the data of location co-ordinates using GPS.

10. The method of claim 7, further performing statistical analysis of the log file using a probabilistic graphical modelling.

11. The method of claim 7, wherein the user device 103 is configured to enable the user to provide physical address of the user/respondent.

12. The method of claim 7, further determining a change in the location and accordingly increases the pinging frequency closer to pre-determined time interval in order to receive the data of location co-ordinates.
